(19) United States
(12) Patent Application Publication
(10) Pub. No.: US 2025/0128316 A1
(43) Pub. Date: Apr. 24, 2025

(54) MATERIAL BAND RIVETING DEVICE

(71) Applicant: CHENG UEI PRECISION INDUSTRY CO., LTD., New Taipei City (TW)

(72) Inventors: ZHAO-YANG GUO, Dong-Guan City (CN); QIAN LIU, Dong-Guan City (CN); MING XIE, Dong-Guan City (CN); CHUNG-TING LIN, New Taipei City (TW)

(21) Appl. No.: 18/752,769

(22) Filed: Jun. 24, 2024

(30) Foreign Application Priority Data
Oct. 19, 2023 (CN) 202322815982.7

(51) Int. Cl. B21J 15/10; B21J 15/02

(52) U.S. Cl. CPC B21J 15/10; B21J 15/02

(57) ABSTRACT

A material band riveting device includes a feeding structure, a riveting structure and a material pulling structure. The riveting structure is disposed to one end of the feeding structure. The riveting structure has a riveting mold, a plurality of locating pins, two first riveting pins, two second riveting pins and two pressing blocks. The plurality of the locating pins are partially disposed in the riveting mold. The two first riveting pins are partially disposed in the riveting mold. Each first riveting pin has a first riveting portion. The two second riveting pins are partially disposed in the riveting mold. Each second riveting pin has a second riveting portion. The material pulling structure is disposed under the feeding structure.

### CROSS-REFERENCE TO RELATED APPLICATION

The present application is based on, and claims priority from, China Patent Application No. 202322815982.7, filed Oct. 19, 2023, the disclosure of which is hereby incorporated by reference herein in its entirety.

### BACKGROUND OF THE INVENTION

### Field of the Invention

The present invention generally relates to a riveting device, and more particularly to a material band riveting device having a higher accuracy, a higher riveting strength, and a higher attaching degree between two material bands.

### Description of the Prior Art

In a process of manufacturing terminals of an electrical connector, a need for fastening two material bands together is existed. Each material band has a plurality of terminals. The plurality of the terminals of the two material bands are assembled. When the terminals of the two material bands are in use, firstly, the two material bands are formed by a stamping process and an electroplating process, then the two material bands are soldered by a soldering equipment, so that the terminals of the two material bands are connected, finally, the two soldered material bands proceed with an injection molding process.

However, the stamping process and the electroplating process need proceeding in two production lines, so the two production lines are needed, and the two production lines need equipping with a lot of corresponding manpower and a lot of packaging materials. As a result, costs of manufacturing the above-mentioned two material bands are higher, and efficiencies of producing the two material bands are lower.

A conventional material band riveting device includes a material stacking device and a riveting equipment. The material stacking device has a first inputting slideway for transmitting a first material band, a second inputting slideway for transmitting a second material band, and a material stacking slideway. The first inputting slideway is communicated with the material stacking slideway. The second inputting slideway is communicated with the material stacking slideway. The first material band and the second material band enter the material stacking slideway, and the first material band and the second material band are stacked. The first material band has a protrusion. The second material band has a riveting hole. When the first material band is to be riveted with the second material band, the protrusion passes through the riveting hole. The riveting equipment is disposed to one side of the material stacking slideway, and the riveting equipment is connected with the material stacking slideway. After the first material band and the second material band are stacked by the material stacking device, the stacked first material band and the second material band enter the riveting equipment. The riveting equipment stamps the protrusion to make the protrusion bent, so that the first material band is riveted with the second material band by the bent protrusion.

The above-mentioned conventional material band riveting device may replace the current soldering equipment, so that a stamping device is seamlessly connected with the conventional material band riveting device to realize continuous work of a subsequent stacking operation and a subsequent riveting operation. Nevertheless, the conventional material band riveting device rivets the first material band with the second material band corresponding to a position of the protrusion. A material stress of a riveting area of the first material band and the second material band is unable to be completely released, so the protrusion is rebounded. An attaching degree between the first material band and the second material band is poor. An accuracy and a riveting strength of the conventional material band riveting device is deficient.

Thus, it is essential to provide an innovative material band riveting device. The innovative material band riveting device has a higher accuracy, a higher riveting strength, and a higher attaching degree between two material bands.

### BRIEF SUMMARY OF THE INVENTION

An object of the present invention is to provide a material band riveting device adapted for riveting a first terminal material band and a second terminal material band. The second terminal material band is disposed under the first terminal material band. The first terminal material band has a plurality of first location holes and a plurality of first riveting holes which vertically penetrate through the first terminal material band. The second terminal material band has a plurality of second location holes, a plurality of second riveting holes and a plurality of protrusions. The plurality of the second location holes and the plurality of the second riveting holes vertically penetrate through the second terminal material band. Several portions of a peripheral wall of each second riveting hole protrude upward to form the plurality of the protrusions. The plurality of the second location holes are corresponding to the plurality of the first location holes. The plurality of the second riveting holes are corresponding to the plurality of the first riveting holes. The plurality of the protrusions pass upward through the plurality of the first riveting holes. The material band riveting device includes a feeding structure, a riveting structure and a material pulling structure. The feeding structure has a first slideway, a second slideway and a material stacking slideway. The second slideway is partially disposed under the first slideway. The material stacking slideway is disposed under the first slideway. The material stacking slideway is disposed in front of the second slideway. The first slideway is communicated with the material stacking slideway. The second slideway is communicated with the material stacking slideway. The first slideway transports the first terminal material band. The second slideway transports the second terminal material band. The riveting structure is disposed to one end of the feeding structure. The riveting structure is connected to the material stacking slideway. The riveting structure has a riveting mold, a plurality of locating pins, two first riveting pins, two second riveting pins and two pressing blocks. The riveting mold has a feeding end, and a discharging end opposite to the feeding end. The plurality of the locating pins are partially disposed in the riveting mold. The plurality of the locating pins are corresponding to the plurality of the first location holes and the plurality of the second location holes. The plurality of the locating pins pass through the first location holes of the first terminal material band and the second location holes of the second terminal material band. The two first riveting pins are partially disposed in the riveting mold. The two first riveting pins are disposed close to the feeding end. Each first riveting pin has a first riveting portion. The first riveting portion of each first riveting pin is corresponding to one protrusion of the second terminal material band. The two second riveting pins are partially disposed in the riveting mold. The two second riveting pins are disposed close to the discharging end. The two second riveting pins are disposed to one ends of the two first riveting pins. The two first riveting pins and the two second riveting pins are corresponding to the plurality of the first riveting holes, the plurality of the second riveting holes and the plurality of the protrusions. Each second riveting pin has a second riveting portion. The second riveting portion of each second riveting pin is corresponding to the one protrusion of the second terminal material band. A first riveting angle of the first riveting portion is smaller than a second riveting angle of the second riveting portion. The two pressing blocks are partially disposed in the riveting mold. The two pressing blocks surround upper portions of the first riveting portions of the two first riveting pins and upper portions of the second riveting portions of the two second riveting pins, respectively. Each pressing block is disposed between two adjacent locating pins. The two pressing blocks are corresponding to the first riveting holes of the first terminal material band and the second riveting holes of the second terminal material band. A lower portion of the first riveting portion presses downward the one protrusion for a first time. A lower portion of the second riveting portion presses downward the one protrusion for a second time. The material pulling structure is disposed under the feeding structure.

Another object of the present invention is to provide a material band riveting device adapted for riveting a first terminal material band and a second terminal material band. The second terminal material band is disposed under the first terminal material band. The first terminal material band has a plurality of first location holes and a plurality of first riveting holes which vertically penetrate through the first terminal material band. The second terminal material band has a plurality of second location holes and a plurality of second riveting holes vertically penetrating through the second terminal material band. Several portions of a peripheral wall of each second riveting hole protrude upward to form a plurality of protrusions. The plurality of the second location holes are corresponding to the plurality of the first location holes. The plurality of the second riveting holes are corresponding to the plurality of the first riveting holes. The plurality of the protrusions pass upward through the plurality of the first riveting holes. The material band riveting device includes a feeding structure, a riveting mold disposed to one end of the feeding structure, a bottom board, a plurality of locating pins, two first riveting pins, two second riveting pins, two pressing blocks and a material pulling structure. The riveting mold has a feeding end, and a discharging end opposite to the feeding end. The bottom board is disposed under the riveting mold. The bottom board has two supporting blocks, and two locating holes penetrating through a top surface of the bottom board along an up-down direction. The two supporting blocks are located in the two locating holes. The two supporting blocks are exposed to the top surface of the bottom board. Each supporting block has two through holes penetrating through a top surface of the supporting block. The plurality of the locating pins are disposed in the riveting mold. The plurality of the locating pins pass through the first location holes of the first terminal material band and the second location holes of the second terminal material band. The two first riveting pins are disposed between two adjacent locating pins. The two first riveting pins are disposed close to the feeding end. Each first riveting pin has a first main body. One end of the first main body extends downward to form a first extending portion. One end of the first extending portion is inclined inward and extended to form a first riveting portion. The first riveting portion of each first riveting pin is pressed downward on one protrusion by a first riveting angle. One end of the first riveting portion extends downward to form a first punching portion. A diameter of the first extending portion is bigger than a diameter of the first punching portion. The first punching portions of the two first riveting pins pass through the first riveting holes of the first terminal material band and the second riveting holes of the second terminal material band, and then the first punching portions of the two first riveting pins are inserted into the through holes of one supporting block. The two second riveting pins are disposed between another two adjacent locating pins. The two second riveting pins are disposed close to the discharging end. Each second riveting pin has a second main body. One end of the second main body extends downward to form a second extending portion. One end of the second extending portion slantwise extends inward and downward to form a second riveting portion. The second riveting portion of each second riveting pin is pressed downward on the one protrusion by a second riveting angle. The first riveting angle of the first riveting portion is smaller than the second riveting angle of the second riveting portion. One end of the second riveting portion extends downward to form a second punching portion. A diameter of the second extending portion is bigger than a diameter of the second punching portion. The second punching portions of the two second riveting pins pass through the first riveting holes of the first terminal material band and the second riveting holes of the second terminal material band, and then the second punching portions of the two second riveting pins are inserted into the through holes of the other supporting block. The two pressing blocks are partially disposed in the riveting mold. The two pressing blocks surround upper portions of the first riveting portions of the two first riveting pins and upper portions of the second riveting portions of the two second riveting pins, respectively. Each pressing block is disposed between two adjacent locating pins. The two pressing blocks are corresponding to the first riveting holes of the first terminal material band and the second riveting holes of the second terminal material band. A lower portion of the first riveting portion presses downward the one protrusion for a first time. A lower portion of the second riveting portion presses downward the one protrusion for a second time. The two supporting blocks are corresponding to the two pressing blocks. The two supporting blocks are disposed under the two pressing blocks, the first terminal material band and the second terminal material band. The material pulling structure is disposed under the feeding structure.

Another object of the present invention is to provide a material band riveting device. The material band riveting device includes a riveting mold, at least one first riveting pin, and at least one second riveting pin. The riveting mold has a feeding end, and a discharging end opposite to the feeding end. The first riveting pins is disposed close to the feeding end. The first riveting pin has a first riveting portion with a first riveting angle. The second riveting pin is disposed in the riveting mold. The second riveting pin is disposed close to the discharging end. The second riveting pin has a second riveting portion with a second riveting angle. The second riveting angle is bigger than the first riveting angle.

As described above, the riveting structure completes the first riveting action and the second riveting action by the two first riveting pins and the two second riveting pins, a flanging shape of a riveting position of the terminal material band with the first punching portions and the second punching portions which have different riveting angles is better than the flanging shape of the riveting position of the terminal material band with punching portions which have the same riveting angle, and an attaching degree between the first terminal material band and the second terminal material band with the first punching portions and the second punching portions which have the different riveting angles is better than the attaching degree between the first terminal material band and the second terminal material band with the punching portions which have the same riveting angle. Furthermore, the stacked first terminal material band and the second terminal material band are riveted by the riveting structure to form the terminal material band, so the first terminal material band and the second terminal material band are combined to lower an electroplating cost, have a simplified process and be conveniently maintained. As a result, the material band riveting device has a higher accuracy, a higher riveting strength, and a higher attaching degree between two material bands which are the first terminal material band and the second terminal material band.

### BRIEF DESCRIPTION OF THE DRAWINGS

The present invention will be apparent to those skilled in the art by reading the following description, with reference to the attached drawings, in which:

FIG. 1 is a perspective view of a material band riveting device according to the present invention;

FIG. 2 is a perspective view of a first terminal material band which is disposed to the material band riveting device according to the present invention;

FIG. 3 is a perspective view of a second terminal material band which is disposed to the material band riveting device according to the present invention;

FIG. 4 is a perspective view of a terminal material band which is disposed to the material band riveting device according to the present invention;

FIG. 5 is a partially perspective view of the material band riveting device according to the present invention;

FIG. 6 is another partially perspective view of the material band riveting device according to the present invention;

FIG. 7 is one more partially perspective view of the material band riveting device according to the present invention;

FIG. 8 is a partial assembling view of a riveting structure of the material band riveting device, wherein the terminal material band is disposed to the material band riveting device according to the present invention;

FIG. 9 is another partial assembling view of the riveting structure of the material band riveting device, wherein the terminal material band is disposed to the material band riveting device according to the present invention;

FIG. 10 is one more partial assembling view of the riveting structure of the material band riveting device, wherein the terminal material band is disposed to the material band riveting device according to the present invention;

FIG. 11 is a partial diagram of the riveting structure of the material band riveting device, wherein the terminal material band is disposed to the material band riveting device according to the present invention;

FIG. 12 is a sectional diagram of the material band riveting device along a line XII-XII of the material band riveting device of FIG. 11;

FIG. 13 is an enlarged view of an encircled portion X1 of the material band riveting device of FIG. 12;

FIG. 14 is an enlarged view of an encircled portion X2 of the material band riveting device of FIG. 12; and

FIG. 15 is another partial diagram of the riveting structure of the material band riveting device, wherein the terminal material band is removed from the material band riveting device according to the present invention.

### DETAILED DESCRIPTION OF THE INVENTION

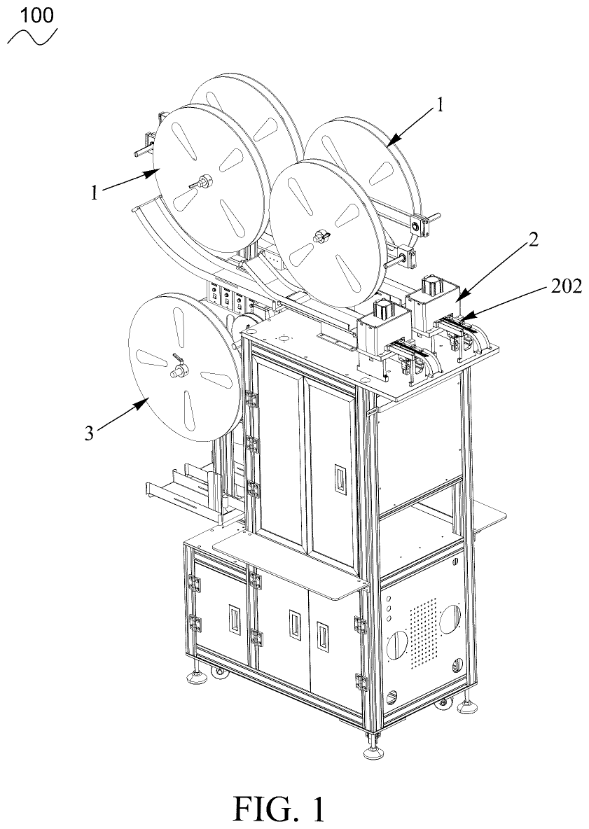

With reference to FIG. 1 to FIG. 3, a material band riveting device 100 according to the present invention is shown. The material band riveting device 100 is adapted for riveting a first terminal material band 4 and the second terminal material band 5. The material band riveting device 100 includes a feeding structure 1, a riveting structure 2 and a material pulling structure 3. In the present invention, the material band riveting device 100 includes two feeding structures 1 and two riveting structures 2. Selectively, the material band riveting device 100 includes a plurality of the feeding structures 1 and a plurality of the riveting structures 2.

The riveting structure 2 is disposed to an end of the feeding structure 1. The two riveting structures 2 are disposed to the ends of the two feeding structures 1. The two riveting structures 2 are disposed to front ends of the two feeding structures 1. The material pulling structure 3 is disposed under the feeding structure 1. The material pulling structure 3 is disposed under the two feeding structures 1. In the present invention, the two feeding structures 1 are defined as a group. The group of the two feeding structures 1 are disposed to two rear ends of the two riveting structures 2. The two riveting structures 2 are corresponding to the two feeding structures 1. Each feeding structure 1 positions the first terminal material band 4 and the second terminal material band 5, the first terminal material band 4 and the second terminal material band 5 are stacked, and the first terminal material band 4 and the second terminal material band 5 are disposed to the feeding structure 1. The second terminal material band 5 is disposed under the first terminal material band 4.

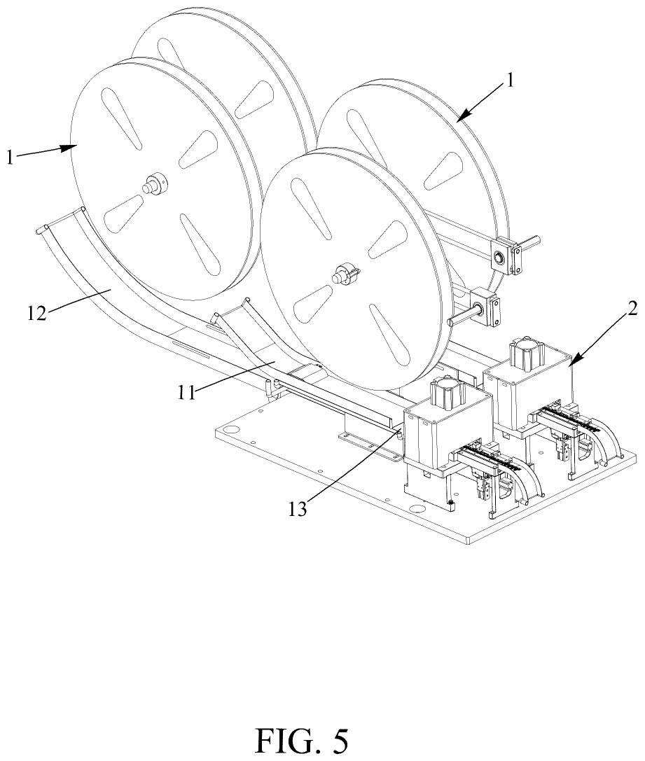

Referring to FIG. 5, the feeding structure 1 has a first slideway 11, a second slideway 12 and a material stacking slideway 13. Specifically, each feeding structure 1 has the first slideway 11, the second slideway 12 and the material stacking slideway 13. The first slideway 11 is disposed to a front end of the second slideway 12. The material stacking slideway 13 is disposed under the first slideway 11. The material stacking slideway 13 is disposed in front of the second slideway 12. The first slideway 11 is partially corresponding to the second slideway 12 along an up-down direction. The second slideway 12 is partially disposed under the first slideway 11. The first slideway 11 is corresponding to the first terminal material band 4. The first slideway 11 is used for transporting the first terminal material band 4. The first slideway 11 is corresponding to a front end of the material stacking slideway 13. The first slideway 11 is communicated with the material stacking slideway 13. The second slideway 12 is corresponding to the second terminal material band 5. The second slideway 12 is used for transporting the second terminal material band 5. The second slideway 12 is corresponding to a rear end of the material stacking slideway 13. The second slideway 12 is communicated with the material stacking slideway 13.

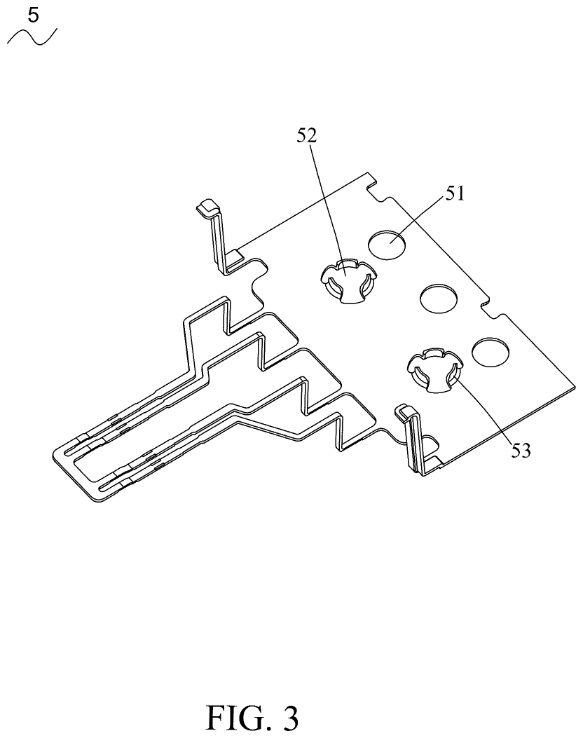

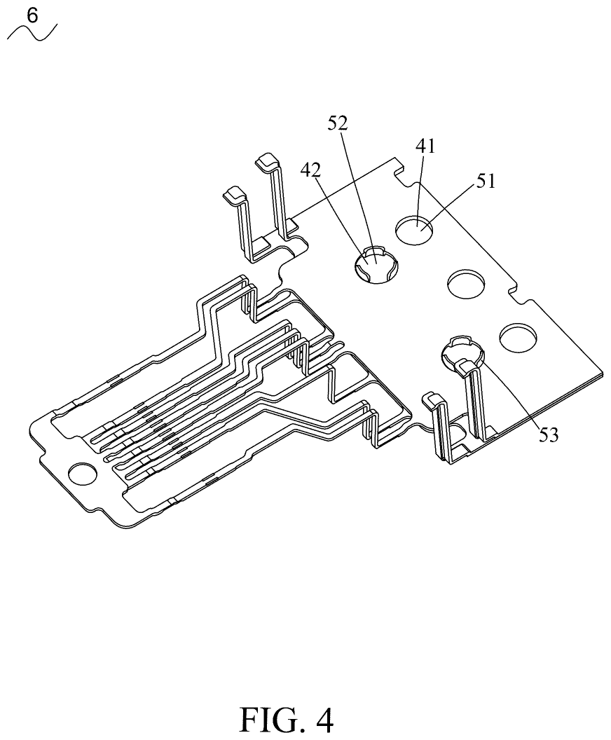

Referring to FIG. 3 to FIG. 6, the riveting structure 2 is connected to the material stacking slideway 13. Each riveting structure 2 is disposed to one end of the material stacking slideway 13 of one feeding structure 1. Each riveting structure 2 is disposed to the front end of the material stacking slideway 13 of the one feeding structure 1. After the first slideway 11 transports the first terminal material band 4 to the material stacking slideway 13, and the second slideway 12 transports the second terminal material band 5 to the material stacking slideway 13, the first terminal material band 4 is stacked with the second terminal material band 5 in the material stacking slideway 13, the stacked first terminal material band 4 and the second terminal material band 5 enter the riveting structure 2, and the stacked first terminal material band 4 and the second terminal material band 5 are riveted by the riveting structure 2 of the material band riveting device 100 to form a terminal material band 6. Specifically, the first terminal material band 4 is disposed on a top surface of the second terminal material band 5. The first terminal material band 4 and the second terminal material band 5 are riveted by the riveting structure 2 to form the terminal material band 6. In the present invention, the terminal material band 6 is capable of reducing an electroplating cost, having a simplified process and being conveniently maintained.

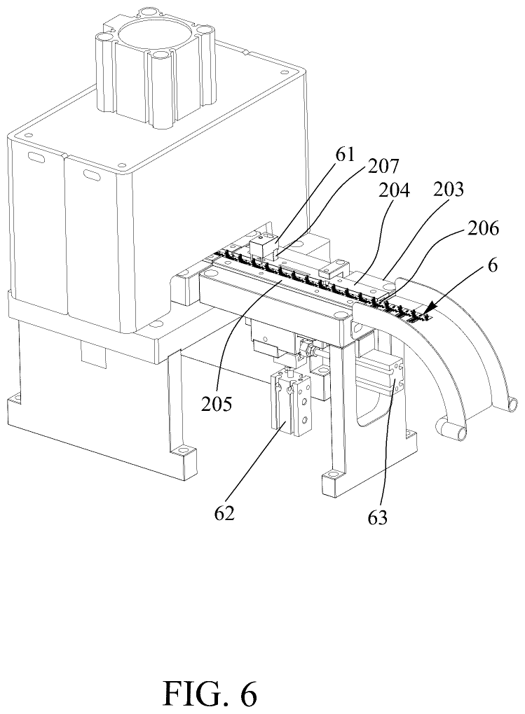

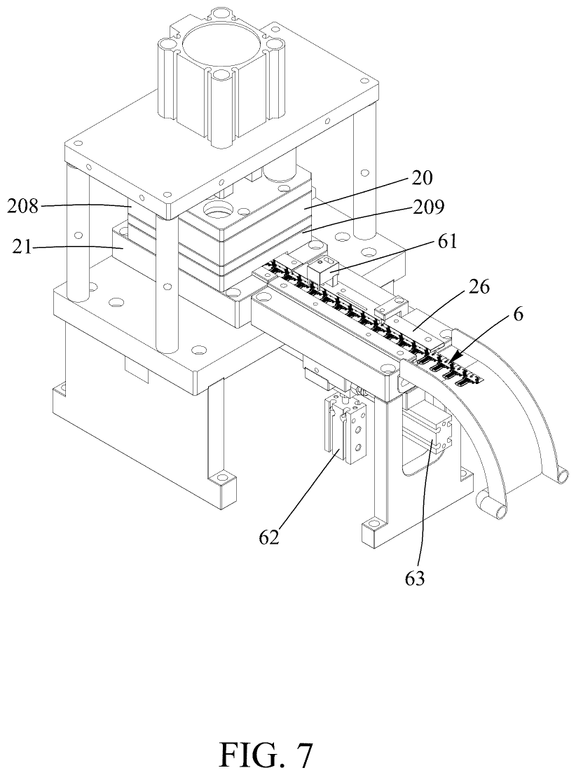

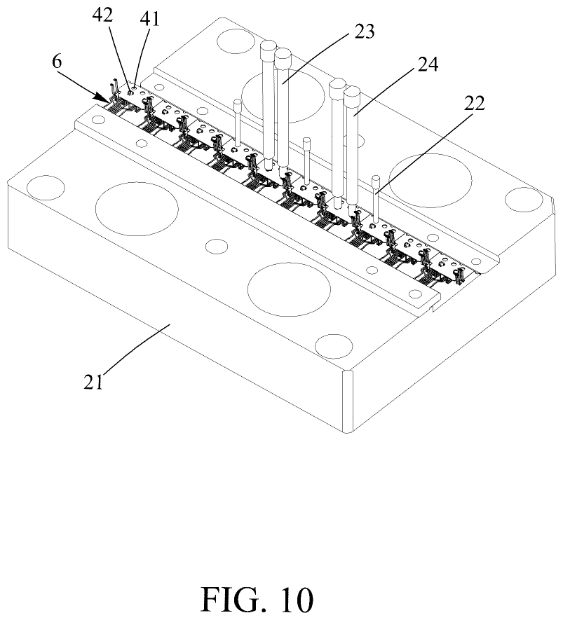

Referring to FIG. 6 to FIG. 10, the riveting structure 2 has a riveting mold 20, a bottom board 21, a plurality of locating pins 22, two first riveting pins 23, two second riveting pins 24, two pressing blocks 25, a covering board 26 and a locating board 27. A rear end and a front end of the riveting mold 20 have a feeding end 208 and a discharging end 209 opposite to the feeding end 208. The riveting mold 20 of the riveting structure 2 is disposed to the end of the feeding structure 1. Specifically, each riveting structure 2 has the riveting mold 20, the bottom board 21, the plurality of locating pins 22, the two first riveting pins 23, the two second riveting pins 24, the two pressing blocks 25, the covering board 26 and the locating board 27. The plurality of the locating pins 22, the two first riveting pins 23, the two second riveting pins 24, the two pressing blocks 25, the covering board 26 and the locating board 27 are partially disposed in the riveting mold 20. Bottoms of the plurality of the locating pins 22, the two first riveting pins 23, the two second riveting pins 24, the two pressing blocks 25, the covering board 26 and the locating board 27 are exposed to a bottom surface of the riveting mold 20. The bottom board 21 is disposed under the riveting mold 20. The bottoms of the plurality of the locating pins 22, the two first riveting pins 23, the two second riveting pins 24, the two pressing blocks 25, the covering board 26 and the locating board 27 are disposed to a top of the bottom board 21. The plurality of the locating pins 22, the two first riveting pins 23, the two second riveting pins 24, the two pressing blocks 25, the covering board 26 and the locating board 27 are mounted between the riveting mold 20 and the bottom board 21.

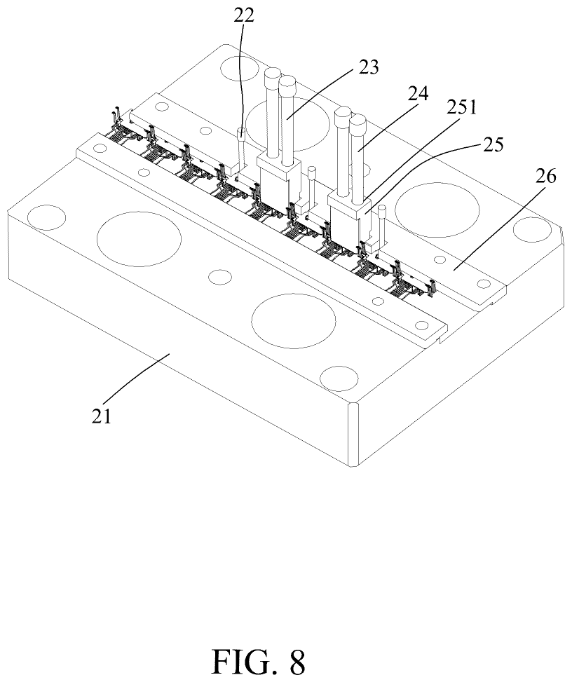

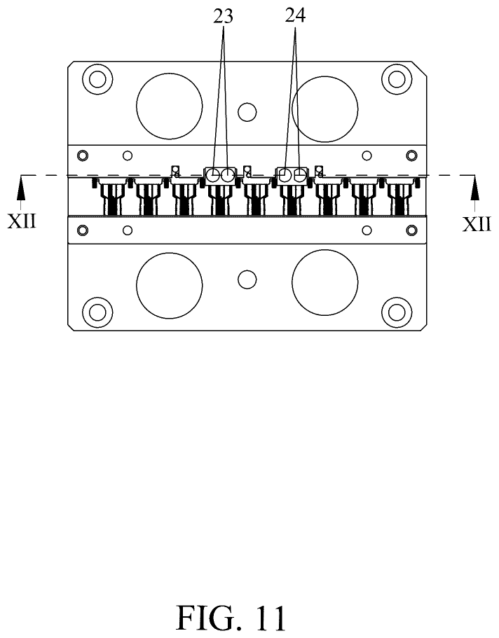

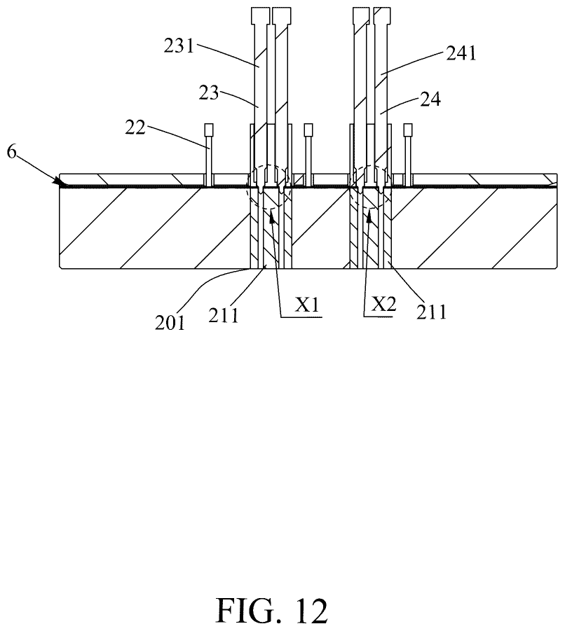

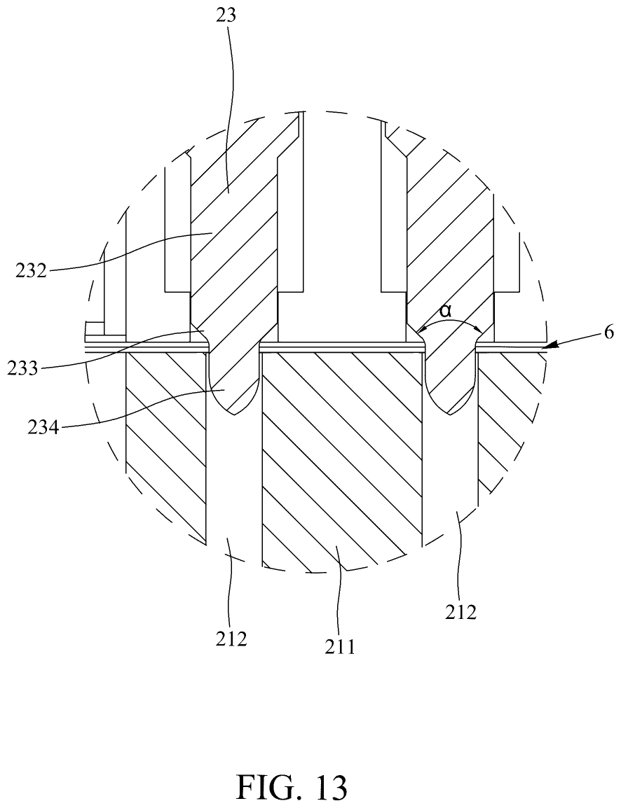

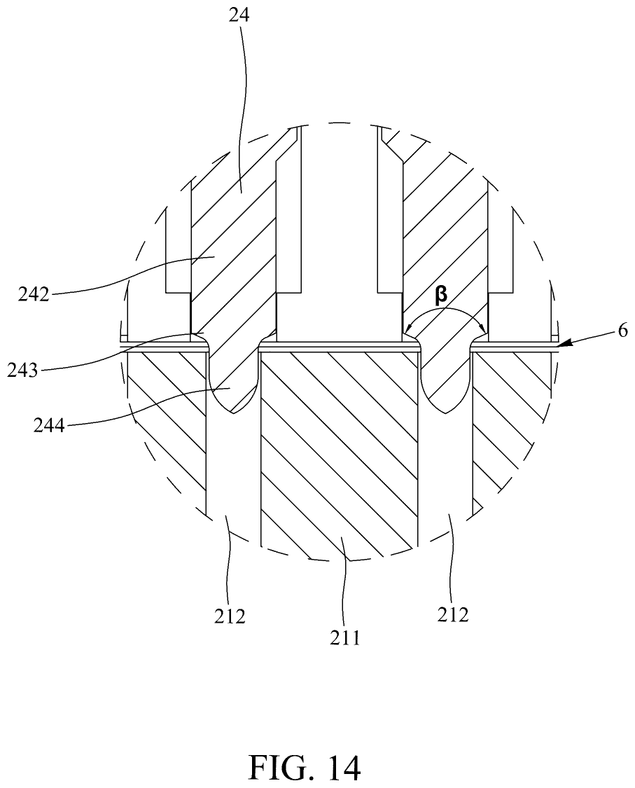

Referring to FIG. 8 to FIG. 14, the bottom board 21 has two supporting blocks 211, two locating holes 201 and a plurality of through holes 212. The two locating holes 201 penetrate through a top surface and a bottom surface of the bottom board 21 along the up-down direction. The two supporting blocks 211 are located in the two locating holes 201. The two supporting blocks 211 are exposed to the top surface and the bottom surface of the bottom board 21. The two supporting blocks 211 are disposed under the two pressing blocks 25, the first terminal material band 4 and the second terminal material band 5. The two supporting blocks 211 are corresponding to the two pressing blocks 25. The plurality of the through holes 212 penetrate through top surfaces and bottom surfaces of the two supporting blocks 211. Each supporting block 211 has two through holes 212 penetrating through the top surface and the bottom surface of the supporting block 211. The through holes 212 of the two supporting blocks 211 are corresponding to the two first riveting pins 23 and the two second riveting pins 24. The first terminal material band 4 and the second terminal material band 5 are positioned between the riveting mold 20 and the bottom board 21.

In a riveting process, the two first riveting pins 23 and the two second riveting pins 24 are inserted into the plurality of the through holes 212 of the two supporting blocks 211 through the terminal material band 6. When the plurality of the through holes 212 are damaged, the two supporting blocks 211 are replaced without replacing the bottom board 21. In the present invention, each riveting structure 2 has three locating pins 22. In a concrete implementation, each riveting structure 2 is without being limited to have the three locating pins 22, the two first riveting pins 23, the two second riveting pins 24 and the two pressing blocks 25.

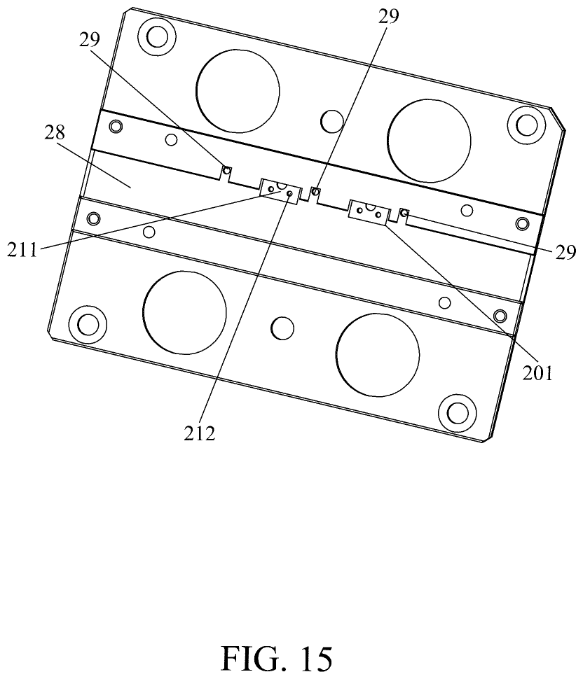

Referring to FIG. 3 to FIG. 15, the two first riveting pins 23 of each riveting structure 2 are disposed close to one side of one feeding structure 1. The two first riveting pins 23 are disposed between two adjacent locating pins 22. The two first riveting pins 23 are disposed close to the feeding end 208 of the riveting structure 2. The two second riveting pins 24 and the two first riveting pins 23 are abreast disposed along a longitudinal direction. The two second riveting pins 24 are disposed to one ends of the two first riveting pins 23. The two second riveting pins 24 are disposed to two front ends of the two first riveting pins 23. The two second riveting pins 24 are disposed between another two adjacent locating pins 22. The two second riveting pins 24 are disposed close to the discharging end 209 of the riveting structure 2. Bottom ends of the two first riveting pins 23 are surrounded by one pressing block 25. Bottom ends of the two second riveting pins 24 are surrounded by the other pressing block 25.

Each pressing block 25 has two fixing holes 251 penetrate through a top surface and a bottom surface of the pressing block 25 along the up-down direction. The two fixing holes 251 are abreast disposed along the longitudinal direction. The plurality of the locating pins 22 are abreast disposed along the longitudinal direction. The bottom ends of the two first riveting pins 23 and the two second riveting pins 24 pass through the fixing holes 251 of the two pressing blocks 25. Each pressing block 25 is disposed between the two adjacent locating pins 22. The two pressing blocks 25 are used for locating the first terminal material band 4 and the second terminal material band 5. When the first terminal material band 4 is riveted with the second terminal material band 5, the two pressing blocks 25 are fastened to the first terminal material band 4 and the second terminal material band 5 to restrict a position of the first terminal material band 4 and a position of the second terminal material band 5 to prevent the first terminal material band 4 and the second terminal material band 5 from moving along the up-down direction, so as to prevent a riveting deviation of the first terminal material band 4 and the second terminal material band 5.

The covering board 26 is mounted to the top surface of the bottom board 21. The covering board 26 is covered to a top surface of one side of the terminal material band 6. The covering board 26 is covered to a top surface of one side of the first terminal material band 4 and a top surface of one side of the second terminal material band 5. The covering board 26 is used for restricting a position of the terminal material band 6 along the up-down direction. When the terminal material band 6 is in a pulling process, the covering board 26 prevents a position deviation of the terminal material band 6 along the up-down direction. The locating board 27 is mounted to the top surface of the bottom board 21. The locating board 27 is covered to the other side of the first terminal material band 4 and the other side of the second terminal material band 5. The locating board 27 is covered to the other side of the terminal material band 6. The locating board 27 is used for restricting the position of the terminal material band 6 along the up-down direction. When the terminal material band 6 is in the pulling process, the locating board 27 prevents the position deviation of the terminal material band 6 along the up-down direction.

The bottom board 21 of each riveting structure 2 has a locating groove 28, and a plurality of inserting holes 29 penetrating through the bottom board 21 along the up-down direction. The locating groove 28 is recessed inward in a middle of the top surface of the bottom board 21, and the locating groove 28 penetrates through a front surface and a rear surface of the bottom board 21 along the longitudinal direction. The first terminal material band 4 and the second terminal material band 5 of the terminal material band 6 are located in the locating groove 28. An inner side of the covering board 26 projects into one side of the locating groove 28. The inner side of the covering board 26 is covered to the one side of the terminal material band 6. An inner side of the locating board 27 projects into the other side of the locating groove 28. The inner side of the locating board 27 is covered to the other side of the terminal material band 6. The top surfaces of the two supporting blocks 211 are exposed to the locating groove 28. The bottoms of the plurality of the locating pins 22, the two first riveting pins 23, the two second riveting pins 24 and the two pressing blocks 25 project into the one side of the locating groove 28. The plurality of the inserting holes 29 vertically penetrate through the riveting structure 2. The plurality of the inserting holes 29 are formed in the locating groove 28. The plurality of the inserting holes 29 penetrate through a bottom wall of the locating groove 28. In the present invention, each riveting structure 2 has three inserting holes 29. The plurality of the inserting holes 29 are corresponding to the bottoms of the plurality of the locating pins 22. The bottoms of the plurality of the locating pins 22 are inserted into the plurality of the inserting holes 29 through the terminal material band 6. A middle of the terminal material band 6 is exposed to a middle of the locating groove 28.

The covering board 26 has a plurality of first lacking grooves 261 and two second lacking grooves 262. The inner side of the covering board 26 which is adjacent to the first terminal material band 4 and the second terminal material band 5 of the terminal material band 6 defines the plurality of the first lacking grooves 261 and the two second lacking grooves 262 penetrating through an inner side surface of the covering board 26. Each second lacking groove 262 is disposed between two adjacent first lacking grooves 261. The plurality of the first lacking grooves 261 are disposed close to the terminal material band 6. The plurality of the first lacking grooves 261 are disposed close to the first terminal material band 4 and the second terminal material band 5. The two second lacking grooves 262 are disposed close to the terminal material band 6. The two second lacking grooves 262 are disposed close to the first terminal material band 4 and the second terminal material band 5. The plurality of the locating pins 22 are corresponding to the plurality of the first lacking grooves 261. The plurality of the locating pins 22 are disposed to the plurality of the first lacking grooves 261. The two pressing blocks 25 are corresponding to the two second lacking grooves 262. The two pressing blocks 25 are disposed to the two second lacking grooves 262.

The material band riveting device 100 further includes a riveting module 202, a location block 61, a locating cylinder 62 and a pulling cylinder 63. The riveting module 202 is mounted to a front end of the riveting structure 2. The location block 61 is disposed to a top surface of the riveting module 202 which is disposed at a front end of the riveting mold 20 of the front end of the riveting structure 2. The riveting module 202 includes a base board 203, a blocking board 204, a limiting board 205, a restricting groove 206 and a propping block 207. The blocking board 204 and the location block 61 are mounted on one side of the base board 203. The limiting board 205 is mounted on the other side of the base board 203. A middle of the base board 203 is recessed downward to form the restricting groove 206 longitudinally penetrating through a front surface and a rear surface of the base board 203. The restricting groove 206 is formed between the blocking board 204 and the limiting board 205. The propping block 207 is mounted to the base board 203 and the blocking board 204. The location block 61 is mounted on the propping block 207. The restricting groove 206 is in alignment with the locating groove 28. The middle of the terminal material band 6 is exposed to the middle of the locating groove 28 and a middle of the restricting groove 206. The location block 61 ensures a riveting position of the first terminal material band 4 and a riveting position of the second terminal material band 5. The locating cylinder 62 is disposed to a bottom surface of the riveting mold 20. The locating cylinder 62 is located under the terminal material band 6. The locating cylinder 62 is used for locating the terminal material band 6. The pulling cylinder 63 is disposed to the bottom surface of the riveting mold 20. The pulling cylinder 63 is disposed to one end of the locating cylinder 62. The pulling cylinder 63 is connected to a front end of the locating cylinder 62. The pulling cylinder 63 is connected with the locating cylinder 62. The pulling cylinder 63 is used for controlling the locating cylinder 62. The pulling cylinder 63 pulls the terminal material band 6, and the pulling cylinder 63 feeds the terminal material band 6.

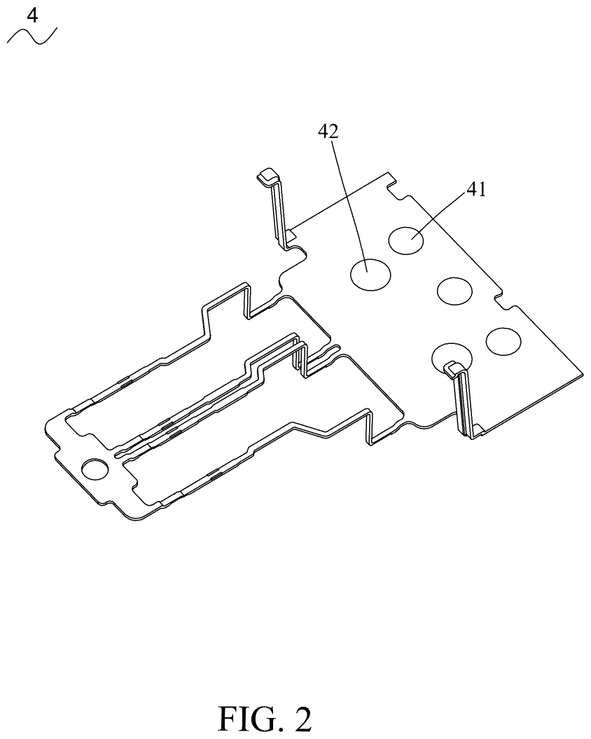

Referring to FIG. 2, the first terminal material band 4 has a plurality of first location holes 41 and a plurality of first riveting holes 42 which vertically penetrate through the first terminal material band 4. The plurality of the first location holes 41 penetrate through the top surface and a bottom surface of the one side of the first terminal material band 4. The plurality of the first riveting holes 42 penetrate through the top surface and the bottom surface of the one side of the first terminal material band 4. The bottoms of the plurality of the locating pins 22 pass through the plurality of the first location holes 41 and a plurality of second location holes 51.

Referring to FIG. 2 and FIG. 3, the second terminal material band 5 has the plurality of the second location holes 51, a plurality of second riveting holes 52 and a plurality of protrusions 53. The plurality of the second location holes 51 and the plurality of the second riveting holes 52 vertically penetrate through the second terminal material band 5. The plurality of the second location holes 51 penetrate through the top surface and a bottom surface of the one side of the second terminal material band 5. The plurality of the second location holes 51 are corresponding to the plurality of the first location holes 41. The plurality of the second riveting holes 52 penetrate through the top surface and the bottom surface of the one side of the second terminal material band 5. The plurality of the second riveting holes 52 are corresponding to the plurality of the first riveting holes 42. Several portions of a peripheral wall of each second riveting hole 52 protrude upward to form the plurality of the protrusions 53. The plurality of the protrusions 53 are disposed around an outer periphery of the second riveting hole 52. The plurality of the protrusions 53 are averagely distributed around the outer periphery of the second riveting hole 52. Each protrusion 53 is disposed along a radial direction of the second riveting hole 52.

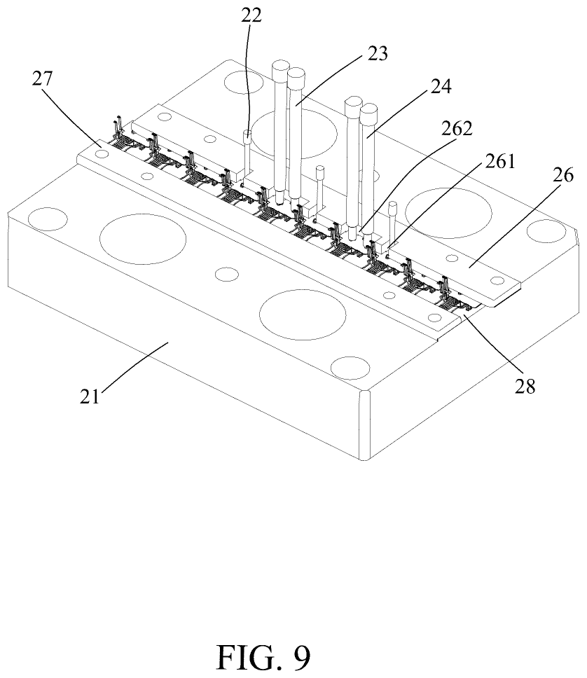

Referring to FIG. 2, FIG. 3, FIG. 8 and FIG. 9, in the present invention, the plurality of the protrusions 53 pass upward through the plurality of the first riveting holes 42. The plurality of the locating pins 22 are corresponding to the plurality of the first location holes 41 and the plurality of the second location holes 51. The two first riveting pins 23 and the two second riveting pins 24 are corresponding to the plurality of the first riveting holes 42, the plurality of the second riveting holes 52 and the plurality of the protrusions 53. The fixing holes 251 of the two pressing blocks 25 are corresponding to the plurality of the first riveting holes 42 and the plurality of the second riveting holes 52. The plurality of the first location holes 41 and the plurality of the second location holes 51 are corresponding to the plurality of the first lacking grooves 261. The plurality of the first riveting holes 42 and the plurality of the second riveting holes 52 are corresponding to the plurality of the second lacking grooves 262.

In the present invention, two riveting actions of the first terminal material band 4 and the second terminal material band 5 which are stacked are operated twice by the two riveting structures 2. The two riveting actions which are operated twice by the two riveting structures 2 include a first riveting action and a second riveting action. The first riveting action is a preriveting action. The first riveting action and the second riveting action ensure a riveting strength and a riveting accuracy of the first terminal material band 4 and the second terminal material band 5. The plurality of the locating pins 22, and the two pressing blocks 25 together with the two first riveting pins 23 and the two second riveting pins 24 move downward at the same time. The plurality of the locating pins 22 pass through the first location holes 41 of the first terminal material band 4 and the second location holes 51 of the second terminal material band 5. The plurality of the locating pins 22 are used for locating the first terminal material band 4 and the second terminal material band 5. At the same time, the two pressing blocks 25 tightly press the first terminal material band 4 and the second terminal material band 5 along the up-down direction. And then, the two first riveting pins 23 and the two second riveting pins 24 press downward. The two first riveting pins 23 are used for the first riveting action. The two second riveting pins 24 are used for the second riveting action.

Referring to FIG. 1 to FIG. 15, when the first riveting action is performed, the two first riveting pins 23 press downward on the plurality of the protrusions 53 of the second terminal material band 5, so the plurality of the protrusions 53 are bent outward and flanged. When the second riveting action is performed, the two second riveting pins 24 press downward on the plurality of the protrusions 53 of the second terminal material band 5, so the plurality of the protrusions 53 are completely attached to the first terminal material band 4, and breakages of the plurality of the protrusions 53 are prevented. A material stress of the riveting position between the first terminal material band 4 and the second terminal material band 5 is completely released by the second riveting action. The plurality of the protrusions 53 are completely attached to the first terminal material band 4, the plurality of the protrusions 53 are without being rebounded. In the present invention, when the first riveting action is performed, a flanged angle of each protrusion 53 which is pressed downward is ninety degrees. When the second riveting action is performed, the flanged angle of each protrusion 53 which is pressed downward is one hundred and thirty degrees. In the concrete implementation, when the first riveting action is performed, the flanged angle of each protrusion 53 which is pressed downward is without being limited to be ninety degrees. When the second riveting action is performed, the flanged angle of each protrusion 53 which is pressed downward is without being limited to be one hundred and thirty degrees.

Referring to FIG. 1 to FIG. 15 again, each first riveting pin 23 has a first main body 231, a first extending portion 232, a first riveting portion 233 and a first punching portion 234. One end of the first main body 231 extends downward to form the first extending portion 232. A middle of a bottom end of the first main body 231 extends downward to form the first extending portion 232. The first main body 231 and the first extending portion 232 are cylindrical. A diameter of the first main body 231 is bigger than a diameter of the first extending portion 232. One end of the first extending portion 232 is inclined inward and extended downward to form the first riveting portion 233. A bottom end of the first extending portion 232 extends downward to form the first riveting portion 233. The first riveting portion 233 is shown as an inverted frustum of a cone shape. An outer periphery surface of the first riveting portion 233 is gradually inclined inward and downward from top to bottom. Each first riveting pin 23 is corresponding to one protrusion 53. The first riveting portion 233 of each first riveting pin 23 is corresponding to the one protrusion 53. The first riveting portion 233 of each first riveting pin 23 is surrounded by the one protrusion 53. The first riveting portion 233 is used for pressing downward the plurality of the protrusions 53 of the second terminal material band 5. The first riveting portion 233 presses downward the one protrusion 53 of the second terminal material band 5.

One end of the first riveting portion 233 extends downward to form the first punching portion 234. A bottom end of the first riveting portion 233 extends downward and then shrinks inward to form the first punching portion 234. An upper portion of the first punching portion 234 is shown as a cylinder shape. A lower portion of the first punching portion 234 is shown as an inverted cone shape. The diameter of the first extending portion 232 is bigger than a diameter of the first punching portion 234. In a riveting process, the first punching portion 234 of each first riveting pin 23 passes through one first riveting hole 42 and one second riveting hole 52, and then the first punching portion 234 is inserted into the through hole 212 of one supporting block 211. Specifically, the first punching portions 234 of the two first riveting pins 23 pass through the first riveting holes 42 of the first terminal material band 4 and the second riveting holes 52 of the second terminal material band 5, and then the first punching portions 234 of the two first riveting pins 23 are inserted into the through holes 212 of the one supporting block 211. The first riveting portion 233 of the first riveting pin 23 presses downward on the one protrusion 53 of the terminal material band 6 by a first riveting angle α. The first riveting angle α is ninety degrees. When the first riveting portion 233 presses downward on the plurality of the protrusions 53, the plurality of the protrusions 53 are flanged outward at the first riveting angle α which is ninety degrees. The first punching portion 234 of each first riveting pin 23 extends beyond the bottom surface of the riveting mold 20, and then the first punching portion 234 of each first riveting pin 23 is inserted into the through hole 212 of the one supporting block 211.

The two second riveting pins 24 are disposed to one ends of the two first riveting pins 23. Each second riveting pin 24 has a second main body 241, a second extending portion 242, a second riveting portion 243 and a second punching portion 244. One end of the second main body 241 extends downward to form the second extending portion 242. A middle of a bottom end of the second main body 241 extends downward to form the second extending portion 242. The second main body 241 and the second extending portion 242 are cylindrical. A diameter of the second main body 241 is bigger than a diameter of the second extending portion 242. A bottom end of the second extending portion 242 extends downward to form the second riveting portion 243. One end of the second extending portion 242 slantwise extends inward and downward to form the second riveting portion 243. The second riveting portion 243 is shown as another inverted frustum of a cone shape. An outer periphery surface of the second riveting portion 243 is gradually inclined inward and downward from top to bottom. The second riveting portion 243 of each second riveting pin 24 is corresponding to the one protrusion 53. The second riveting portion 243 is used for pressing the protrusions 53 of the second terminal material band 5. The second riveting portion 243 presses downward the plurality of the protrusions 53 of the second terminal material band 5, so the protrusions 53 of the second terminal material band 5 are completely attached to the first terminal material band 4.

One end of the second riveting portion 243 extends downward to form the second punching portion 244. A bottom end of the second riveting portion 243 extends downward and then shrinks inward to form the second punching portion 244. An upper portion of the second punching portion 244 is shown as another cylinder shape. A lower portion of the second punching portion 244 is shown as another inverted cone shape. The diameter of the second extending portion 242 is bigger than a diameter of the second punching portion 244. The second punching portion 244 of each second riveting pin 24 projects out of the bottom surface of the riveting mold 20. In a secondary riveting process, the second punching portions 244 of the two second riveting pins 24 pass through the first riveting holes 42 of the first terminal material band 4 and the second riveting holes 52 of the second terminal material band 5, and then the second punching portions 244 of the two second riveting pins 24 are inserted into the through holes 212 of the other supporting block 211. The second riveting portion 243 of each second riveting pin 24 presses downward on the one protrusion 53 of the second terminal material band 5 of the terminal material band 6 by a second riveting angle β. The second riveting angle β is one hundred and thirty degrees. When the second riveting portion 243 of each second riveting pin 24 presses downward on the one protrusion 53 of the second terminal material band 5, the plurality of the protrusions 53 are completely attached to the first terminal material band 4. In the present invention, the second riveting angle β of the second riveting portion 243 is bigger than the first riveting angle α of the first riveting portion 233.

In the secondary riveting process, the second riveting angles β of the two second punching portions 244 of each riveting structure 2 are different from the first riveting angles α of the two first punching portions 234 of each riveting structure 2. A flanging shape of the riveting position of the terminal material band 6 with the first punching portions 234 and the second punching portions 244 which have the different riveting angles is better than the flanging shape of the riveting position of the terminal material band 6 with the punching portions which have the same riveting angle. An attaching degree between the first terminal material band 4 and the second terminal material band 5 with the first punching portions 234 and the second punching portions 244 which have the different riveting angles is better than the attaching degree between the first terminal material band 4 and the second terminal material band 5 with the punching portions which have the same riveting angle. The material stress of the riveting position of the terminal material band 6 is completely released by the second riveting action. The plurality of the protrusions 53 of the second terminal material band 5 are completely attached to the first terminal material band 4, and the plurality of the protrusions 53 are without being rebounded.

In the present invention, the plurality of the locating pins 22 and the two pressing blocks 25 of the two riveting structures 2 move downward at the same time, The two pressing blocks 25 are corresponding to the first riveting portions 233 of the two first riveting pins 23 and the second riveting portions 243 of the two second riveting pins 24, respectively. The two pressing blocks 25 surround upper portions of the first riveting portions 233 of the two first riveting pins 23 and upper portions of the second riveting portions 243 of the two second riveting pins 24, respectively. The two pressing blocks 25 are corresponding to the first riveting holes 42 of the first terminal material band 4 and the second riveting holes 52 of the second terminal material band 5. A lower portion of the first riveting portion 233 presses downward the one protrusion 53 for a first time, a lower portion of the second riveting portion 243 presses downward the one protrusion 53 for a second time.

The plurality of the locating pins 22 pass through the first location holes 41 of the first terminal material band 4 and second location holes 51 of the second terminal material band 4 to locate the first terminal material band 4 and the second terminal material band 5. At the same time, the two pressing blocks 25 tightly press downward on the first terminal material band 4 and the second terminal material band 5 along the up-down direction, and then, the two first riveting pins 23 and the two second riveting pins 24 press downward. The first riveting portion 233 of each first riveting pin 23 is pressed downward on the one protrusion 53 of the second terminal material band 5 of the terminal material band 6 by the first riveting angle α. The protrusion 53 of the second terminal material band 5 is flanged outward at the first riveting angle α. The first riveting angle α is ninety degrees.

The first punching portion 234 of each first riveting pin 23 passes through one first riveting hole 42 and one second riveting hole 52, and then the first punching portion 234 of each first riveting pin 23 is inserted into the through hole 212 of the one supporting block 211. The second riveting portion 243 of each second riveting pin 24 is pressed downward on the one protrusion 53 of the second terminal material band 5 of the terminal material band 6 by the second riveting angle β. The second riveting angle β is one hundred and thirty degrees. The first riveting angle α of the first riveting portion 233 is smaller than the second riveting angle β of the second riveting portion 243. When the second riveting portion 243 of each second riveting pin 24 is pressed downward on the one protrusion 53 of the second terminal material band 5, the one protrusion 53 is completely attached to the first terminal material band 4. The second punching portions 244 of the two second riveting pins 24 pass through the first riveting holes 42 of the first terminal material band 4 and the second riveting holes 52 of the second terminal material band 5, the second punching portions 244 of the two second riveting pins 24 extend beyond the bottom surface of the riveting mold 20, and then the second punching portions 244 of the two second riveting pins 24 are inserted into the through holes 212 of the two supporting blocks 211.

As described above, the riveting structure 2 completes the first riveting action and the second riveting action by the two first riveting pins 23 and the two second riveting pins 24, the flanging shape of the riveting position of the terminal material band 6 with the first punching portions 234 and the second punching portions 244 which have the different riveting angles is better than the flanging shape of the riveting position of the terminal material band 6 with the punching portions which have the same riveting angle, and the attaching degree between the first terminal material band 4 and the second terminal material band 5 with the first punching portions 234 and the second punching portions 244 which have the different riveting angles is better than the attaching degree between the first terminal material band 4 and the second terminal material band 5 with the punching portions which have the same riveting angle. Furthermore, the stacked first terminal material band 4 and the second terminal material band 5 are riveted by the riveting structure 2 to form the terminal material band 6, so the first terminal material band 4 and the second terminal material band 5 are combined to lower the electroplating cost, have the simplified process and be conveniently maintained. As a result, the material band riveting device 100 has a higher accuracy, a higher riveting strength, and a higher attaching degree between two material bands which are the first terminal material band 4 and the second terminal material band 5.

What is claimed is:

1. A material band riveting device adapted for riveting a first terminal material band and a second terminal material band, the second terminal material band being disposed under the first terminal material band, the first terminal material band having a plurality of first location holes and a plurality of first riveting holes which vertically penetrate through the first terminal material band, the second terminal material band having a plurality of second location holes, a plurality of second riveting holes and a plurality of protrusions, the plurality of the second location holes and the plurality of the second riveting holes vertically penetrating through the second terminal material band, several portions of a peripheral wall of each second riveting hole protruding upward to form the plurality of the protrusions, the plurality of the second location holes being corresponding to the plurality of the first location holes, the plurality of the second riveting holes being corresponding to the plurality of the first riveting holes, the plurality of the protrusions passing upward through the plurality of the first riveting holes, the material band riveting device comprising:
a feeding structure having a first slideway, a second slideway and a material stacking slideway, the second slideway being partially disposed under the first slideway, the material stacking slideway being disposed under the first slideway, the material stacking slideway being disposed in front of the second slideway, the first slideway being communicated with the material stacking slideway, the second slideway being communicated with the material stacking slideway, the first slideway transporting the first terminal material band, the second slideway transporting the second terminal material band;
a riveting structure disposed to one end of the feeding structure, the riveting structure being connected to the material stacking slideway, the riveting structure having:
a riveting mold having a feeding end, and a discharging end opposite to the feeding end;
a plurality of locating pins partially disposed in the riveting mold, the plurality of the locating pins being corresponding to the plurality of the first location holes and the plurality of the second location holes, the plurality of the locating pins passing through the first location holes of the first terminal material band and the second location holes of the second terminal material band;
two first riveting pins partially disposed in the riveting mold, the two first riveting pins being disposed close to the feeding end, each first riveting pin having a first riveting portion, the first riveting portion of each first riveting pin being corresponding to one protrusion of the second terminal material band;
two second riveting pins partially disposed in the riveting mold, the two second riveting pins being disposed close to the discharging end, the two second riveting pins being disposed to one ends of the two first riveting pins, the two first riveting pins and the two second riveting pins being corresponding to the plurality of the first riveting holes, the plurality of the second riveting holes and the plurality of the protrusions, each second riveting pin having a second riveting portion, the second riveting portion of each second riveting pin being corresponding to the one protrusion of the second terminal material band, a first riveting angle of the first riveting portion being smaller than a second riveting angle of the second riveting portion; and
two pressing blocks partially disposed in the riveting mold, the two pressing blocks surrounding upper portions of the first riveting portions of the two first riveting pins and upper portions of the second riveting portions of the two second riveting pins, respectively, each pressing block being disposed between two adjacent locating pins, the two pressing blocks being corresponding to the first riveting holes of the first terminal material band and the second riveting holes of the second terminal material band, a lower portion of the first riveting portion pressing downward the one protrusion for a first time, a lower portion of the second riveting portion pressing downward the one protrusion for a second time; and
a material pulling structure disposed under the feeding structure.

2. The material band riveting device as claimed in claim 1, wherein the riveting structure has a bottom board, the bottom board is disposed under the riveting mold, bottoms of the plurality of the locating pins, the two first riveting pins, the two second riveting pins and the two pressing blocks are disposed to a top of the bottom board, the bottom board has two supporting blocks and two locating holes, the two locating holes penetrate through a top surface and a bottom surface of the bottom board along an up-down direction, the two supporting blocks are located in the two locating holes, the two supporting blocks are exposed to the top surface and the bottom surface of the bottom board, the two supporting blocks are disposed under the two pressing blocks, the two supporting blocks are corresponding to the two pressing blocks.

3. The material band riveting device as claimed in claim 2, wherein each supporting block has two through holes penetrating through a top surface and a bottom surface of the supporting block, the through holes of the two supporting blocks are corresponding to the two first riveting pins and the two second riveting pins, the first terminal material band and the second terminal material band are positioned between the riveting mold and the bottom board, the two first riveting pins and the two second riveting pins are inserted into the plurality of the through holes of the two supporting blocks.

4. The material band riveting device as claimed in claim 3, wherein each first riveting pin has a first main body, one end of the first main body extends downward to form a first extending portion, a diameter of the first main body is bigger than a diameter of the first extending portion, one end of the first extending portion is inclined inward and extended downward to form the first riveting portion, the first riveting portion is surrounded by the one protrusion, the first riveting portion presses downward the plurality of the protrusions, one end of the first riveting portion extends downward to form a first punching portion, the diameter of the first extending portion is bigger than a diameter of the first punching portion, the first punching portion passes through one first riveting hole and one second riveting hole, and then the first punching portion is inserted into the through hole of one supporting block.

5. The material band riveting device as claimed in claim 4, wherein the first main body and the first extending portion are cylindrical.

6. The material band riveting device as claimed in claim 4, wherein an upper portion of the first punching portion is shown as a cylinder shape, a lower portion of the first punching portion is shown as an inverted cone shape.

7. The material band riveting device as claimed in claim 4, wherein each second riveting pin has a second main body, one end of the second main body extends downward to form a second extending portion, a diameter of the second main body is bigger than a diameter of the second extending portion, one end of the second extending portion slantwise extends inward and downward to form the second riveting portion, the second riveting portion presses downward the plurality of the protrusions, one end of the second riveting portion extends downward to form a second punching portion, the diameter of the second extending portion is bigger than a diameter of the second punching portion, the second punching portions of the two second riveting pins pass through the first riveting holes of the first terminal material band and the second riveting holes of the second terminal material band, and then the second punching portions of the two second riveting pins are inserted into the through holes of the other supporting block.

8. The material band riveting device as claimed in claim 7, wherein the second main body and the second extending portion are cylindrical.

9. The material band riveting device as claimed in claim 7, wherein an upper portion of the second punching portion is shown as another cylinder shape, a lower portion of the second punching portion is shown as another inverted cone shape.

10. The material band riveting device as claimed in claim 2, wherein the riveting structure has a covering board, the covering board is mounted to the top surface of the bottom board, the covering board is covered to a top surface of one side of the first terminal material band and a top surface of one side of the second terminal material band, the covering board is partially disposed in the riveting mold, a bottom of the covering board is exposed to the riveting mold.

11. The material band riveting device as claimed in claim 2, wherein the riveting structure has a covering board, an inner side of the covering board which is adjacent to the first terminal material band and the second terminal material band defines a plurality of first lacking grooves and two second lacking grooves penetrating through an inner side surface of the covering board, the plurality of the locating pins are corresponding to the plurality of the first lacking grooves, the plurality of the locating pins are disposed to the plurality of the first lacking grooves, the two pressing blocks are corresponding to the two second lacking grooves, the two pressing blocks are disposed to the two second lacking grooves, each second lacking groove is disposed between two adjacent first lacking grooves.

12. The material band riveting device as claimed in claim 1, wherein the first riveting portion is shown as an inverted frustum of a cone shape, the second riveting portion is shown as another inverted frustum of a cone shape.

13. A material band riveting device adapted for riveting a first terminal material band and a second terminal material band, the second terminal material band being disposed under the first terminal material band, the first terminal material band having a plurality of first location holes and a plurality of first riveting holes which vertically penetrate through the first terminal material band, the second terminal material band having a plurality of second location holes and a plurality of second riveting holes vertically penetrating through the second terminal material band, several portions of a peripheral wall of each second riveting hole protruding upward to form a plurality of protrusions, the plurality of the second location holes being corresponding to the plurality of the first location holes, the plurality of the second riveting holes being corresponding to the plurality of the first riveting holes, the plurality of the protrusions passing upward through the plurality of the first riveting holes, the material band riveting device comprising:
a feeding structure;
a riveting mold disposed to one end of the feeding structure, the riveting mold having a feeding end, and a discharging end opposite to the feeding end;
a bottom board disposed under the riveting mold, the bottom board having two supporting blocks, and two locating holes penetrating through a top surface of the bottom board along an up-down direction, the two supporting blocks being located in the two locating holes, the two supporting blocks being exposed to the top surface of the bottom board, each supporting block having two through holes penetrating through a top surface of the supporting block;
a plurality of locating pins disposed in the riveting mold, the plurality of the locating pins passing through the first location holes of the first terminal material band and the second location holes of the second terminal material band;
two first riveting pins disposed between two adjacent locating pins, the two first riveting pins being disposed close to the feeding end, each first riveting pin having a first main body, one end of the first main body extending downward to form a first extending portion, one end of the first extending portion being inclined inward and extended downward to form a first riveting portion, the first riveting portion of each first riveting pin being pressed downward on one protrusion by a first riveting angle, one end of the first riveting portion extending downward to form a first punching portion, a diameter of the first extending portion being bigger than a diameter of the first punching portion, the first punching portions of the two first riveting pins passing through the first riveting holes of the first terminal material band and the second riveting holes of the second terminal material band, and then the first punching portions of the two first riveting pins being inserted into the through holes of one supporting block;
two second riveting pins disposed between another two adjacent locating pins, the two second riveting pins being disposed close to the discharging end, each second riveting pin having a second main body, one end of the second main body extending downward to form a second extending portion, one end of the second extending portion slantwise extending inward and downward to form a second riveting portion, the second riveting portion of each second riveting pin being pressed downward on the one protrusion by a second riveting angle, the first riveting angle of the first riveting portion being smaller than the second riveting angle of the second riveting portion, one end of the second riveting portion extending downward to form a second punching portion, a diameter of the second extending portion being bigger than a diameter of the second punching portion, the second punching portions of the two second riveting pins passing through the first riveting holes of the first terminal material band and the second riveting holes of the second terminal material band, and then the second punching portions of the two second riveting pins being inserted into the through holes of the other supporting block;
two pressing blocks partially disposed in the riveting mold, the two pressing blocks surrounding upper portions of the first riveting portions of the two first riveting pins and upper portions of the second riveting portions of the two second riveting pins, respectively, each pressing block being disposed between two adjacent locating pins, the two pressing blocks being corresponding to the first riveting holes of the first terminal material band and the second riveting holes of the second terminal material band, a lower portion of the first riveting portion pressing downward the one protrusion for a first time, a lower portion of the second riveting portion pressing downward the one protrusion for a second time, the two supporting blocks being corresponding to the two pressing blocks, the two supporting blocks being disposed under the two pressing blocks, the first terminal material band and the second terminal material band; and
a material pulling structure disposed under the feeding structure.

14. A material band riveting device comprising:
a riveting mold having a feeding end, and a discharging end opposite to the feeding end;
at least one first riveting pin disposed in the riveting mold, the first riveting pin being disposed close to the feeding end, the first riveting pin having a first riveting portion with a first riveting angle; and
at least one second riveting pin disposed in the riveting mold, the second riveting pin being disposed close to the discharging end, the second riveting pin having a second riveting portion with a second riveting angle;
wherein the second riveting angle is bigger than the first riveting angle.

15. The material band riveting device as claimed in claim 14, wherein the first riveting angle is ninety degrees, the second riveting angle is one hundred and thirty degrees.

16. The material band riveting device as claimed in claim 14, wherein the first riveting pin has a first main body, a first extending portion extended downward from the first main body, and a first punching portion extended downward from the first riveting portion, the first riveting portion is slantwise extended inward and downward from the first extending portion, a diameter of the first main body is bigger than a diameter of the first extending portion, the diameter of the first extending portion is bigger than a diameter of the first punching portion, the second riveting pin has a second main body, a second extending portion extended downward from the second main body, and a second punching portion extended downward from the second riveting portion, the second riveting portion is slantwise extended inward and downward from the second extending portion, a diameter of the second main body is bigger than a diameter of the second extending portion, the diameter of the second extending portion is bigger than a diameter of the second punching portion.

17. The material band riveting device as claimed in claim 14, further comprising two pressing blocks disposed in the riveting mold, the two pressing blocks surrounding an upper portion of the first riveting portion of the first riveting pin and an upper portions of the second riveting portion of the second riveting pin, respectively.

18. The material band riveting device as claimed in claim 17, wherein the riveting mold has a plurality of locating pins, the first riveting pin is disposed between two adjacent locating pins, the second riveting pin is disposed between another two adjacent locating pins, each pressing block is disposed between two adjacent locating pins.

19. The material band riveting device as claimed in claim 16, wherein the riveting mold is disposed above a bottom board, the bottom board has a plurality of through holes, the plurality of the through holes are corresponding to the first punching portion and the second punching portion.

20. The material band riveting device as claimed in claim 19, further comprising a covering board mounted between the riveting mold and the bottom board, the covering board defining a plurality of first lacking grooves and two second lacking grooves penetrating through an inner side surface of the covering board, the plurality of the locating pins being disposed to the plurality of the first lacking grooves, the two pressing blocks being disposed to the two second lacking grooves.
